(19) United States
(12) Patent Application Publication
(10) Pub. No.: US 2025/0378236 A1
(43) Pub. Date: Dec. 11, 2025

(54) SYSTEMS AND METHODS FOR OPTIMIZING SALTWATER DISPOSAL RESERVOIRS

(71) Applicant: ConocoPhillips Company, Houston, TX (US)

(72) Inventors: Chung-Kan HUANG, Houston, TX (US); Dylan VENNES, Houston, TX (US); Mazaruny RINCONES, Houston, TX (US); Yong ZHAO, Houston, TX (US); Pallav SHARMA, Houston, TX (US); Dayanara BETANCOURT, Houston, TX (US)

(21) Appl. No.: 19/191,552

(22) Filed: Apr. 28, 2025

Related U.S. Application Data
(60) Provisional application No. 63/639,062, filed on Apr. 26, 2024.

(51) Int. Cl. G06F 30/27; G06F 119/14; G06Q 10/04; G06Q 50/02

(52) U.S. Cl. CPC G06F 30/27; G06Q 10/04; G06Q 50/02; G06F 2119/14

(57) ABSTRACT

Implementations described and claimed herein provide systems and methods for optimizing saltwater disposal and development. One implementation includes receiving reservoir data and pressure data from at least one of a computing device, one or more sensors, or one or more databases; generating uncertainty parameters using the reservoir data; identifying one or more pressure events at one or more locations using the pressure data; generating correlated pressure data based on a correlation of the one or more pressure events with historical data; generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and generating an optimized development plan for the reservoir using the prediction data.

### CROSS-REFERENCE TO RELATED APPLICATIONS

The present application claims priority to U.S. Provisional Application No. 63/639,062, entitled “Pressure prediction in saltwater disposal reservoirs” filed on Apr. 26, 2024, which is specifically incorporated by reference herein in its entirety.

### FIELD

Aspects of the present disclosure relate generally to systems and methods for optimizing systems for natural resource production and more particularly to optimizing development plans for saltwater disposal reservoirs.

### BACKGROUND

Unconventional reservoirs are generally more complex than conventional reservoirs in terms of volume and development. Examples of unconventional reservoirs include, but are not limited to, low permeability oil, tight gas sands, gas shales, coalbed methane, gas hydrates, and oil shales. Long-term disposal of water produced from hydraulically fractured shale/tight reservoirs during flowback, and primary production is a challenge. The method of saltwater disposal (SWD) depends on a number of factors, notably the geology of the formation from which the water is produced, as well as the technology and infrastructure available in the area. Most saltwater is disposed of at specialty disposal sites where the saltwater is injected by way of a disposal well into natural underground formations.

Setting up and maintaining a reliable development plan can be challenging due to complex geology and sparse and unreliable pressure data, which produce inaccurate models with poor conditioning and limited forecasting capabilities. Furthermore, SWD in shallow formations above shale reservoirs poses drilling and completion (D&C) risks for unconventional reservoirs.

It is with these observations in mind, among others, that various aspects of the present disclosure were conceived and developed.

### SUMMARY

Implementations described and claimed herein address the foregoing problems by providing systems and methods for generating an optimized development plan for unconventional reservoirs. The implementations described and claimed herein increase efficiency to allow more frequent and dynamic pressure forecasting for a large amount of complex factors, while still maintaining accurate results.

In some examples, systems and methods provided herein prevent overfitting and generate accurate development plans and/or probabilistic pressure forecasts based on underlying uncertainty. In some aspects, systems and methods provided herein may be updated more efficiently and/or provide a robust development plan that can be continuously updated as data is obtained. In some aspects, systems and methods provided herein may be used to generate forecasts and/or optimize development plans in real time.

In some examples, systems and methods are provided with a combined physics and machine learning model for fast modeling in combination with reservoir physics, thus producing a highly automated approach to integrate data, combined with an ensemble approach that accounts for multiple uncertainties to enable robust pressure prediction in SWD reservoirs. In some aspects, the disclosed technology optimizes future SWD activities to maximize asset value by avoiding large injection volume in high pressure spots. In one aspect, the disclosed technology provides a tool to understand the uncertainty from geology and well completion perspectives and potential impact of SWD activities on development plan decisions.

In some examples, systems and methods provided herein provide an automated and rapid data-physics engine that provides efficient and real-time or near real-time model updates, decreases uncertainty, and provides more reliable development plans. In some aspects, embedding ensemble smoothing and filtering in an automated data-physics engine accounts for multiple uncertainties and enables robust and accurate pressure prediction and/or development plans. In some aspects, disclosed systems and methods can efficiently utilize datasets with missing data by generating data using semi-synthetic simulation models. In some aspects, systems and methods provided herein are easy to set up and maintain and may be updated continuously when new data is available.

In some examples, the techniques described herein relate to a method for optimizing saltwater disposal, the method including: receiving reservoir data and pressure data from at least one of a computing device, one or more sensors, or one or more databases; generating uncertainty parameters using the reservoir data; identifying one or more pressure events at one or more locations using the pressure data; generating correlated pressure data based on a correlation of the one or more pressure events with historical data; generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and generating an optimized development plan for the reservoir using the prediction data.

In some examples, the techniques described herein relate to a method, further including: modifying at least one of a drilling operation or a well operation using the optimized development plan. In some examples, the techniques described herein relate to a method, wherein the reservoir data includes at least one of a top hole pressure, a bottom hole pressure, a reservoir pressure, a mud weight, or a kick pressure.

In some examples, the techniques described herein relate to a method, further including: generating an output based on the prediction data, the output including at least one of a pressure map or a plot for the reservoir. In some examples, the techniques described herein relate to a method, wherein the one or more machine learning models are trained by: updating the uncertainty parameters; and reducing a distribution of the uncertainty parameters.

In some examples, the techniques described herein relate to a method, wherein the historical data includes at least one of historical pressure data or historical injection data. In some examples, the techniques described herein relate to a method, wherein the one or more machine learning models are trained by determining differences between the correlated pressure data and the uncertainty parameters.

In some examples, the techniques described herein relate to one or more tangible non-transitory computer-readable storage media storing computer-executable instructions for performing a computer process on a computing system, the computer process including: receiving reservoir data and pressure data from at least one of a computing device, one or more sensors, or one or more databases; generating uncertainty parameters using the reservoir data; identifying one or more pressure events at one or more locations using the pressure data; generating correlated pressure data based on a correlation of the one or more pressure events with historical data; generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and generating an optimized development plan for the reservoir using the prediction data.

In some examples, the techniques described herein relate to one or more tangible non-transitory computer-readable storage media storing additional computer-executable instructions for performing the computer process, the computer process further including: modifying at least one of a drilling operation or a well operation using the optimized development plan.

In some examples, the techniques described herein relate to one or more tangible non-transitory computer-readable storage media, wherein the reservoir data includes at least one of a top hole pressure, a bottom hole pressure, a reservoir pressure, a mud weight, or a kick pressure.

In some examples, the techniques described herein relate to one or more tangible non-transitory computer-readable storage media storing additional computer-executable instructions for performing the computer process, the computer process further including: generating an output based on the prediction data, the output including at least one of a pressure map or a plot for the reservoir.

In some examples, the techniques described herein relate to one or more tangible non-transitory computer-readable storage media, wherein the one or more machine learning models are trained by: updating the uncertainty parameters; and reducing a distribution of the uncertainty parameters.

In some examples, the techniques described herein relate to one or more tangible non-transitory computer-readable storage media, wherein the historical data includes at least one of historical pressure data or historical injection data.

In some examples, the techniques described herein relate to one or more tangible non-transitory computer-readable storage media, wherein the one or more machine learning models are trained by determining differences between the correlated pressure data and the uncertainty parameters.

In some examples, the techniques described herein relate to a system for optimizing a development plan for a natural resource production system, the system including: a processing system in communication with a computing device, one or more sensors and one or more databases over a network, the processing system receiving reservoir data and pressure data from at least one of the computing device, the one or more sensors, or the one or more databases; an uncertainty estimation system generating uncertainty parameters using the reservoir data; a correlation system identifying one or more pressure events at one or more locations using the pressure data and generating correlated pressure data based on a correlation of the one or more pressure events with historical data; and an optimization system generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and generating an optimized development plan for the reservoir using the prediction data.

In some examples, the techniques described herein relate to a system, further including an output system generating an output based on the prediction data, the output including at least one of a pressure map or a plot for the reservoir. In some examples, the techniques described herein relate to a system, wherein the reservoir data includes at least one of a top hole pressure, a bottom hole pressure, a reservoir pressure, a mud weight, or a kick pressure.

In some examples, the techniques described herein relate to a system, wherein the one or more machine learning models are trained by determining differences between the correlated pressure data and the uncertainty parameters. In some examples, the techniques described herein relate to a system, wherein the optimization system modifies at least one of a drilling operation or a well operation using the optimized development plan.

In some examples, the techniques described herein relate to a system, wherein the optimization system generates a command to cause saltwater to be injected into a disposal well in the reservoir based on the optimized development plan.

Additionally, the systems and operations disclosed herein represent an improvement to the technical field of prediction modeling. For instance, the systems and methods can generate an optimized development plan from vast amounts of data from a plurality of oil and gas production systems without human intervention. Moreover, data can be leveraged to provide a highly efficient and effective analysis of a large number or oil and gas production systems. These techniques are rooted in technology and could not have existed prior to the advent of prediction modeling.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for optimizing development plans for saltwater disposal reservoirs.

FIG. 2 illustrates an example processing system for optimizing development plans for saltwater disposal reservoirs.

FIG. 3 illustrates an example computing system that may implement various aspects of the systems discussed herein.

FIG. 4 illustrates an example graphical representation of a data process for the example system.

FIG. 5A illustrates an example graphical representation of pore pressure at a first year for an example reservoir.

FIG. 5B illustrates an example graphical representation of pore pressure at a second year for an example reservoir.

FIG. 6A illustrates a graphical representation of an example area including SWD injectors and pressure events.

FIG. 6B illustrates a graphical representation of example data for the example area in FIG. 6A.

FIG. 7A illustrates a graphical representation of an example synthetic sector model for the example area in FIGS. 6A and 6B.

FIG. 7B illustrates a graphical representation of actual water injections and simulated monitoring pressures for the example synthetic sector model of FIG. 7A.

FIG. 8A illustrates a graphical representation of example performance analytics including synthetic pressure data.

FIG. 8B illustrates a graphical representation of example performance analytics including synthetic pressure data with fault blocks.

FIG. 9A illustrates a graphical representation of example performance analytics including actual pressure data.

FIG. 9B illustrates a graphical representation of example performance analytics including actual pressure data with fault blocks.

FIG. 10A illustrates an example graphical representation of improved uncertainty using the various systems and methods discussed herein.

FIG. 10B illustrates an example graphical representation of pressure prediction using the various systems and methods discussed herein.

FIG. 11 illustrates an example graphical representation of forecast pressure that may be used and/or generated using the various systems and methods described herein.

FIG. 12 illustrates example operations for optimizing a development plan for saltwater disposal using the various systems and methods described herein.

### DETAILED DESCRIPTION

Aspects of the present disclosure involve systems and methods for optimizing development plans for saltwater disposal reservoirs of natural resource production systems. Generally, the presently disclosed technology generates an optimized development plan using a data physics-based approach that provides a framework to optimize development plans of saltwater disposal (SWD) wells for oil and gas systems by avoiding large injection volume in high-pressure areas. In one implementation, the systems and methods described herein simulate reservoir conditions for SWD wells in a reservoir to prevent increased pressures that may adversely affect oil production in unconventional resources.

In one aspect, the systems and methods described herein execute and/or train a physics based machine learning models to simulate SWD reservoirs. The model simplifies complex parameters to a minimum while still following the physics constraints present under reservoir conditions. The physics-based machine learning model allows for a high resolution solution with minimal user input. The disclosed technology results in an automated system that can be updated frequently whenever new data is available. In some aspects, the disclosed systems and methods offer excellent long-term predictive capacity and physically realistic responses, even when historical data is suboptimal (e.g., sparse, missing or noisy).

In some aspects, the disclosed technology predicts the production impact of certain activities in order to explore a range of wide possibilities (e.g., millions of scenarios) with improved speed. Through this speed, repeated comparison permits statistically quantifiable comparative prediction performance between many alternative scenarios, resulting in quantitative optimization. Such quantitative optimization mitigates D&C risks, provides a powerful tool to optimize SWD activity, improves the production of oil and gas systems, and maximizes asset value. The system and method described herein allows for SWD injections to avoid high pressure zones that can adversely affect oil and gas production, thereby improving asset performance and reducing D&C risks.

In some aspects, the disclosed technology is automated and maintains a reliable and optimized reservoir development plan. The use of an automated and rapid data-physics engine increases updates, decreases uncertainty, and makes the development plan more reliable. In an aspect, embedding ensemble smoothing and filtering in an automated data-physics engine accounts for multiple uncertainties and enables robust pressure prediction. The disclosed technology efficiently utilizes a limited amount of data to predict the pressure responses due to water injection using the data generated from semi-synthetic simulation models. Other advantages will be apparent from the present disclosure.

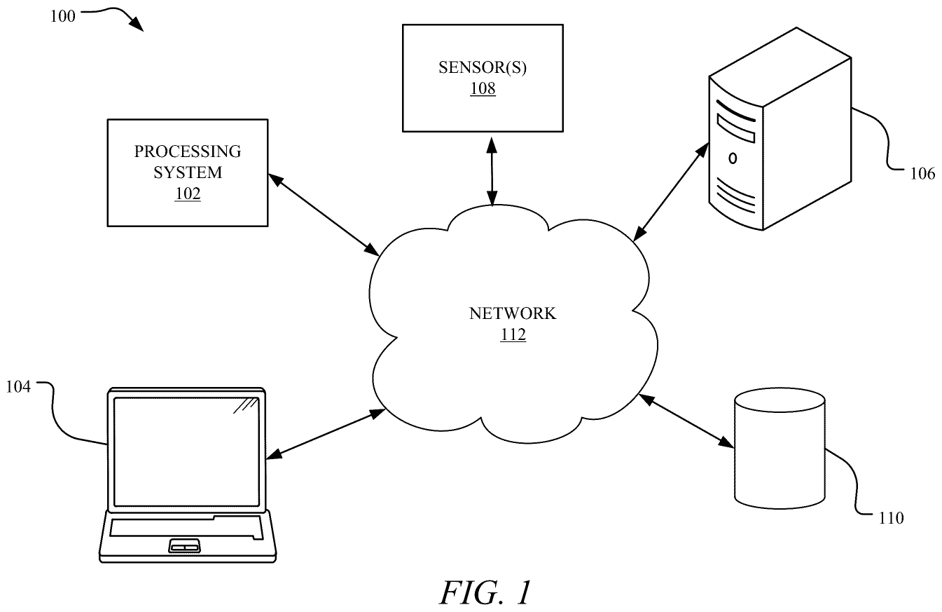

FIG. 1 illustrates an example system 100 that may implement various systems and methods discussed herein. The system 100 may include a processing system 102 configured to communicate with one or more user devices 104, one or more servers 106, one or more sensors 108, and/or one or more databases 110 via a network 112.

As depicted in FIG. 1, a network 112 is used by one or more computing devices or data storage devices for implementing the systems and methods for optimization of an unconventional reservoir. In one implementation, various components of the system 100, one or more user devices 104, one or more servers 106, one or more sensors 108, one or more databases 110, and/or other network components or computing devices described herein are communicatively connected to the network 112.

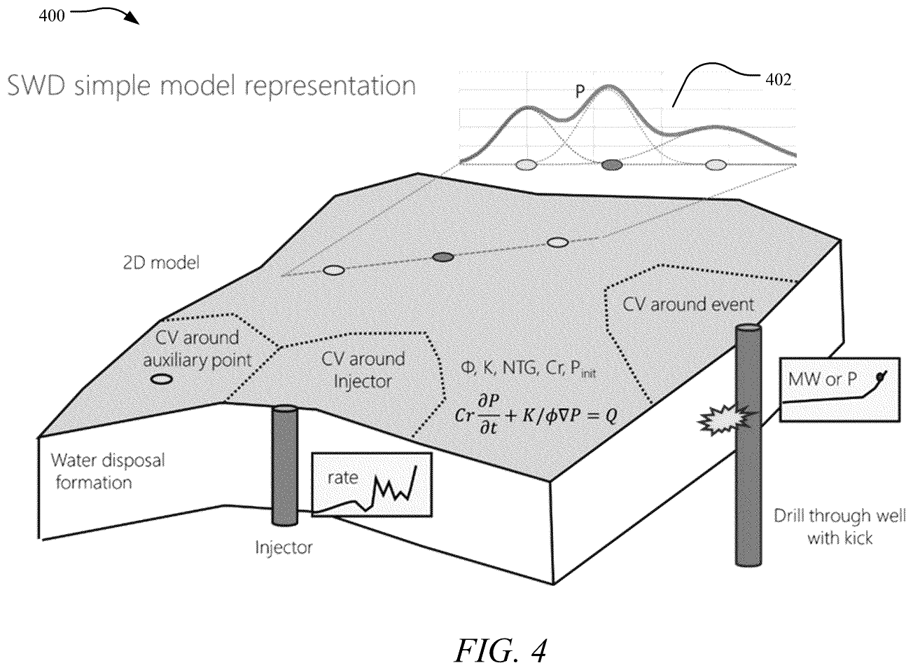

The user device 104 can be a terminal, personal computer, smartphone, tablet, laptop, workstation, or other personal computing device used by an individual (e.g., the operator) to receive notifications and enter data via one or more input and/or output systems. These systems may be part of or separate from the user device 104. For instance, the operator can input data related to one or more wells into the processing system 102 through interactive user interfaces on the user device 104. In some cases, the user device 104 may output data such as display plots, analytical information, notifications, and alerts using graphical user interfaces, like those illustrated in FIGS. 4-11. The user interface may also be used to interact with data, including graphical representations from FIGS. 4-11, training data, forecast SWD parameters, development plans, pressure maps, and uncertainty parameters, as non-limiting examples. In some examples, the server 106 may host the system.

Additionally or alternatively, the server 106 may host a website or an application that users may visit to access the system 100. The server 106 may be a single server, a plurality of servers with each server being a physical server or a virtual machine, or a collection of physical servers and virtual machines. In another implementation, a cloud hosts one or more components of the system. The system 100, the user devices 104, the server 106, and other resources connected to the network 112 may access one or more additional servers for access to one or more websites, applications, web services, interfaces, etc. that are used for resource development and/or generating development plan(s). In one implementation, the server 106 may also host a search engine that the system uses for accessing and modifying information, including without limitation, reservoir data, parameters, a user interface, etc.

In one implementation, the one or more databases 110 may be used to store reservoir data, such as structured and unstructured data captured from disparate sources associated with the unconventional reservoir(s). Some of the reservoir data may be captured directly, for example using one or more sensors 108 deployed at unconventional reservoir(s). Such data may include core, well log, fluid sampling, production data, disposal well injection rates, disposal well pressure data, disposal zone pressure data derived from injection surface pressure data, mud weight data from well kick events, location data, top hole pressure, bottom hole pressure, reservoir pressure, kick pressure, etc. Additionally or alternatively, some of the raw reservoir data, such as drilling and completion parameters, may be obtained from public sources in accordance with regulatory requirements. In some examples, the reservoir data may include data input or otherwise obtained via an interface, at the direction of one or more computing units, and/or the like.

In some examples, at least a portion of the data is obtained by one or more sensors 108 disposed in a well or at a surface during well tests or reservoir tests and/or well operation. For instance, pressure and flow rates are continuously monitored throughout operation of a well using one or more pressure sensors and one or more flow rate sensors. The system 100 is configured to receive user inputs via one or more input systems using, for example, the user device 104 to input text, audio, and/or interact with an interactive user interface displayed on one or more output systems of, for example, the user device 104. The processing system 102, the user device 104, the one or more sensors 108, and the one or more databases 110 are configured to interact with one another via a network(s) 112. In an implementation, the data is received directly from the one or more sensors 108 via a wired or wireless connection. As illustrated in greater detail below, any and/or all of the processing system 102, the user device(s) 104, and the one or more databases 110 may, in some instances, be special-purpose computing devices configured to perform specific functions.

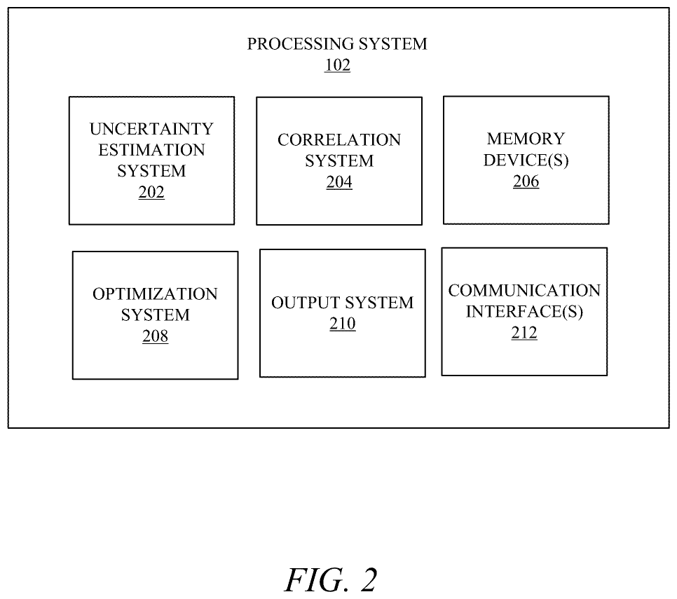

FIG. 2 illustrates an example processing system 102 that may implement various systems and methods discussed herein. The processing system 102 includes one or more computing devices (e.g., servers, routers, user interface devices, internet telephony computing device, and the like) that store and/or retrieve data in the one or more databases 110, generate user interfaces, etc. The processing system 102 may include an uncertainty estimation system 202, a correlation system 204, one or more memory device(s) 206, an optimization system 208, and/or an output system 210 as described further with regards to FIG. 2. The processing system 102 may include a communication interface(s) 212 that is able to communicate with the one or more input systems and one or more output systems via the network(s) 112. For instance, the communication interface(s) 212 may be a network interface configured to support communication between the processing system 102 and the network(s) 112.

The processing system 102 can be configured to execute one or more algorithms to perform the techniques, as discussed in greater detail below. For instance, the one or more algorithms can include one or more machine learning algorithms. The one or more machine learning algorithms can be one or more models, such as, for example, a linear regression model, an unsupervised neural network model, gradient boosted trees, random decision forest, etc. The one or more machine learning models may be built from historical data associated with unconventional reservoirs and/or events for an area that includes unconventional reservoirs and may be stored, for example, at one or more databases. Thus, the one or more machine learning models leverage historical data to generate optimized saltwater development plans. The processing system 102 can be configured to monitor and store (e.g., with appropriate permissions) data for further analysis and/or training of the machine learning model(s). In an implementation, the processing system 102 is configured to transmit data related to the machine learning model(s) to another computing device or database, such as the one or more databases 110. In an implementation, the processing system 102 is associated with an organization or entity.

In an implementation, the processing system 102 includes instructions that direct and/or cause the uncertainty estimation system 202 to execute processing techniques on the data to generate uncertainty data. The uncertainty estimation system 202 may provide the uncertainty data to the correlation system 204, the optimization system 208, and or the output system 210. The correlation system 204 may identify one or more pressure events and/or locations to generate correlated pressure data and may provide the correlated pressure data to the optimization system 208 and/or the output system for generating a development plan. The output system 210 may execute processing techniques to output the development plan. In some examples, the output of the development plan may include visual representations, such as plots, maps, pressure maps, bar graphs, or other graphical illustrations that may be provided via user interface on for example, a computing device, such as user device 104.

Data may be exchanged sequentially and/or simultaneously among the uncertainty estimation system 202, the correlation system 204, the optimization system 208, and/or the output system 210 so that the systems may coordinate while executing processing techniques. The uncertainty estimation system 202, the correlation system 204, and/or the optimization system 208 can be configured to execute one or more algorithms to perform the techniques. For instance, the one or more algorithms can include one or more machine learning algorithms. The one or more machine learning algorithms can be one or more models, such as, for example, a linear regression model, an unsupervised neural network model, gradient boosted trees, random decision forest, etc. The one or more machine learning models may be built from historical data associated with oil and gas production systems that is stored, for example, at one or more databases 110. In an implementation, the uncertainty data and/or the pressure data is generated by processing large amounts of data associated with a large number of oil and gas production systems (e.g., well completions, geology, and well spacing, etc.), in real-time or near real-time, to allow for analysis of an oil or gas production system to assist in optimization decisions, such as, for example, development plans involving well spacing, well completions, well designs (e.g., needing additional casing strings), protests of well permits, well operations (e.g., drilling schedules), and/or legal agreements (e.g., water offtake contracts).

In an implementation, the uncertainty estimation system 202 uses a statistical algorithm, such as, for example, a reservoir model to generate uncertainty data for a reservoir or an area including one or more reservoirs. The uncertainty estimation system 202 may use the available reservoir data to generate SWD parameters and/or uncertainty parameters. Saltwater deposit (SWD) parameters, such as top-hole pressure (THP), bottom hole pressure (BHP), reservoir pressure, mud weight (MW), kick pressure, or any combination of these parameters, may be generated from the raw reservoir data. The reservoir model may generate geological information, fluid properties, and rock-fluid interactions, which are referred to as uncertainty parameters. The uncertainty parameters generated may include, for example, density, viscosity, relative permeability, capillary pressure, ϕ (porosity), K (permeability), NTG (net to gross), Cr (rock/pore compressibility), Pᵢₙᵢₜ (initial pressure data), or any combination of these parameters. The uncertainty estimation system 202 may calculate and/or generate uncertainty parameters and/or a distribution of uncertainty parameters from the reservoir data using a reservoir model, for example.

The reservoir model may be a Low order continuous scale simulation (LOCSIM), for example, which is a mixed domain decomposition method for comprehensive modeling of connected fault vectors, which allows modeling flows with open, partially open and closed faults, and/or and a dual point scheme-based no flow boundaries, which enforces the first and second pressure derivative in a normal direction. Solutions may be computed at solutions points, which may be at the location of the wells or at pressure event points (where pressure data is measured). In the context of SWD modeling, LOCSIM solves the water flow equation in porous media where the pressure is solved at the solutions points.

The LOCSIM may utilize a radial basis function (RBF), which is a real-valued function φ whose value depends only on the distance between the input and some fixed point, either the origin, so that φ(x)=φ\hat{ }(∥x∥), or some other fixed point c, called a center, so that φ(x)=φ\hat{ }(∥x−c∥). Any function φ that satisfies the property φ(x)=φ\hat{ }(∥x∥) is a radial function. The RBFs can be used to approximate solutions and uncertainty parameters for areas where rate and/or pressure data is not available (e.g., at some well locations). The uncertainty estimation system 202 may use such a reservoir model in order to generate uncertainty data which may be provided to the correlation system 204.

Additionally, the uncertainty estimation system 202 may use forecasted SWD parameters to generate initial pressure maps. The uncertainty estimation system 202 may provide the forecasted SWD parameters and/or the initial pressure maps to the correlation system 204, the optimization system 208, and/or the output system 210.

The correlation system 204 may identify locations of wells and/or pressure events (e.g., along a completion interval (Kh)) and associate the locations and/or pressure events with historical injection and pressure data to produce correlated pressure data. In some examples, the correlation system 204 may execute simultaneously or relatively simultaneously to the uncertainty estimation system 202. The correlation system 204 may use the locations, pressure events, historical injection data, and pressure data to generate correlated pressure data, which may be used to adjust the uncertainty parameters, and may be provided to the optimization system 208 and/or the output system 210. In an implementation, the pressure event is an instance of a pressure measured by the one or more sensors 108, such as, for example a pressure sensor, falling outside an expected range.

The optimization system 208 can execute algorithms using uncertainty data from the uncertainty estimation system 202 and/or correlated pressure data from the correlation system 204. The optimization system 208 employs a data physics engine and an ensemble-based approach, utilizing multiple realizations (MR) to capture uncertainty. The data physics engine may be any combination of machine learning and one or more physics models used to simulate reservoir properties while maintaining realistic physics constraints for the reservoir. In an implementation, the reservoir properties are input into the data physics engine to generate predicted reservoir properties, such as, for example, a predicted pressure change of a reservoir undergoing saltwater disposal. Discrepancies are quantitatively captured, allowing for updates to uncertainty parameters. For example, Ensemble Smoothing with Multiple Data Assimilation (ESMDA) and an Ensemble Kalman filter (EnKF) may be used to update uncertainty parameters based on the mismatch between the simulated and observed data. The model training involves both global parameters, such as porosity (ϕ), permeability (K), net to gross (NTG), and rock/pore compressibility (Cr), and local parameters like pore volume (PV) and completion interval (Kh) at pressure event locations. Training may be conducted with a larger data set followed by a limited data set for back-testing, using ESMDA iterations for preconditioning followed by EnKF. Training may include 1-10 iterations, although more iterations may be used. In an implementation, the optimization system 208 generates a command to cause saltwater to be injected into a disposal well in the reservoir based on an optimized development plan. In an implementation, the optimized development plan is generated by the optimization system 208 using the prediction data generated by the data physics engine.

The optimization system 208 ensures efficient data smoothing, particularly for inconsistent or poorly scaled data, by executing smoothing functions multiple times. In some examples, ensemble smoothing may be employed by using an Ensemble Smoother using Multiple Data Assimilation and/or an Ensemble Kalman Filter. The data physics engine, with a minimized vector RBF representation, is updated using an ensemble-based MR process to refine uncertainty. Flow equations are solved in each realization with minimal solution points and approximated using continuous functions for a high-resolution model with reduced uncertainty.

The optimization system 208 generates solutions approximated with continuous functions for high-resolution development plans and SWD models using ESMDA/EnKF for robust pressure predictions. The executed processes are automated with minimal or no user input and integrated for rapid model calibration and forecasting, allowing recalibration with new data sets. Embedding the ESMDA/EnKF process accounts for multiple uncertainties in the data. This structured approach ensures that the optimization system 208 effectively manages uncertainty and enhances model accuracy through integrated processes and advanced algorithms.

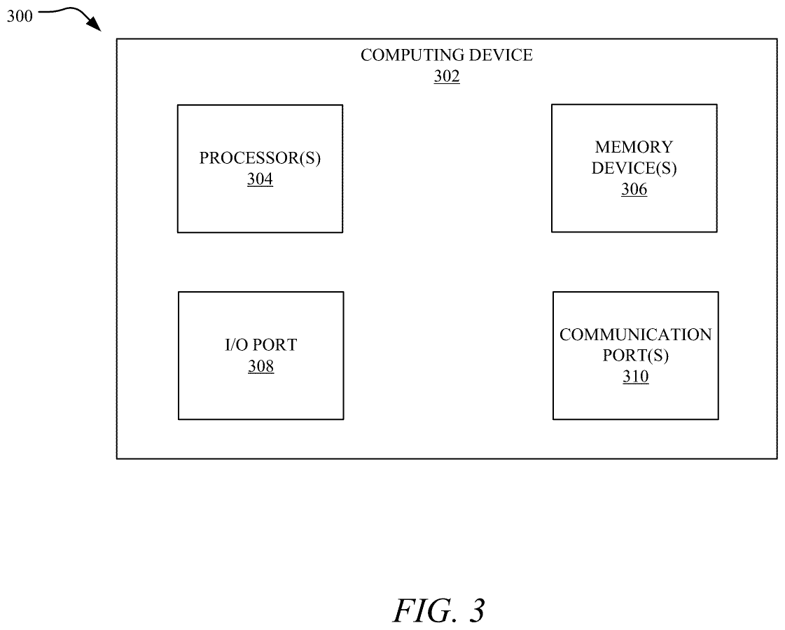

Referring to FIG. 3, a detailed description of an example computing system 300 having at least one computing device 302 that may implement various systems and methods discussed herein is provided. The computing device 302 may be applicable to the system 100, the server 106, the user devices 104, the processing system 102, and other computing or network devices. It will be appreciated that specific implementations of these devices may be of differing possible specific computing architectures not all of which are specifically discussed herein but will be understood by those of ordinary skill in the art.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems described herein. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems in FIGS. 1-3, receives various types of input data (e.g., the sensor data, well data, etc.) and transforms the input data through various stages of the data flow into new types of data files (e.g., well development plans, optimization data, etc.). Moreover, these new data files are transformed further into output data and sent to the computing device 302 to provide information regarding the data, which enables the computing device 302 to do something it could not do before-using probabilistic water forecasts with pressure prediction simulations to optimize well development plans.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302. The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In some implementations, environment transducer devices may convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

The computing device 302 set forth in FIG. 3 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

FIG. 4 shows an example graphical representation of a data process 400 for the example system 100. An example SWD 2D model representation 402 is depicted, where flow equations may be solved in each realization with a minimum number of solution points. FIG. 4 depicts an SWD 2D model developed to improve minimum reservoir vector model used to model oil and gas production, even in instances where reservoir data does not include production rates and/or BHP well data is not available. In some examples, forecasted SWD parameters (as described above with regards to FIG. 2) may be used to generate pressure maps to inform water management for unconventional reservoirs, thus enabling the optimization of SWD management and minimization of high pressure locations.

Using the available reservoir data, the SWD parameters are retrieved, uncertainty parameters are identified (e.g., ϕ, K, NTG, Cr, Pinit), and distribution of the uncertainty parameters is calculated from the data. Locations of the wells and pressure events (e.g., along a completion interval (Kh)) are identified and associated with historical injection and pressure data. The data physics engine with a minimized vector RBF representation is then updated using an ensemble based multiple realization (MR) process to capture and refine uncertainty. Using a data physics engine, the flow equations are solved in each realization with a minimum number of solution points as calculated based on the uncertainty inherent in the underlying data. Flow equation solutions are then approximated using a continuous function to achieve a high resolution model with reduced uncertainty. The ESMDA/EnKF is then used to update the uncertainty parameters based on the mismatch between simulated and observed raw data. In order to accommodate large and frequent data updates, the workflow must be automated and integrated to calibrate the model rapidly and provide a forecast. By automating the workflow, the model and assumptions can be recalibrated with new data sets. Embedding the ESMDA/EnKF process into workflow accounts for multiple uncertainties and enables robust pressure predictions.

For example, an Ensemble Kalman filter (EnKF) may be used, which is a recursive filter suitable for data assimilation problems with a large number of variables including, specifically numerical simulation models, where the probability density function (PDF) is represented by an ensemble (X):

$$X = [ {x}_{1} , … , {x}_{N} ] = [ {x}_{i} ]$$

Where X is an n×N matrix whose columns are the ensemble members. Subsequent data (d) is input into an m×N matrix:

$$D = [ {d}_{1} , … , {d}_{N} ] = [ {d}_{i} ] , {d}_{i} = d + {∈}_{i} , {∈}_{i} ∼ N ( 0 , R )$$

Such that each column dᵢ consists of the data vector d plus a random vector from the m-dimensional normal distribution N(0,R). The columns of X are a sample from the prior probability distribution, and the posterior probability distribution is then:

$$\hat{X} = X + K ( D - H X )$$

The EnKF is then the sample covariance C computed from the ensemble members:

$$K = C {{H}^{T} ( H C {H}^{T} + R )}^{- 1} .$$

ESMDA is an iterative ensemble smoother which performs multiple smaller corrections across the data ensemble iteratively. For any number of data assimilations (Na) the coefficient ai for i=1, . . . , Na where the ensemble is run from t0 for each ensemble member by perturbing the observation vector:

$${d}_{u c} = {d}_{o b s} + \sqrt{{α}_{i}} {C}_{D}^{1 / 2} {z}_{d} ,$$

where z_{d} is approximately N(0,I_{N4}). The ensemble is subsequently updated while inverting the N_{d}×N_{d} matrix C given by:

$$C = {C}_{D D}^{f} + {C}_{D} .$$

Various techniques may be used to test the smoothing functions and ensure the data can be efficiently smoothed, especially if the data is not consistent and/or poorly scaled. In some examples, in order to ensure that the ESMDA smoothing does not artificially enhance poorly defined data, the ensemble data may be smoothed multiple times from 1-10 times, 2-5 times, or a specified number of times (e.g., 1, 2, 3, 4, 5, 6, 7, 8, 9, or 10 times), as non-limiting examples. The data may be smoothed more times, such as 15, 20, 50, etc., and/or may be customized by a user.

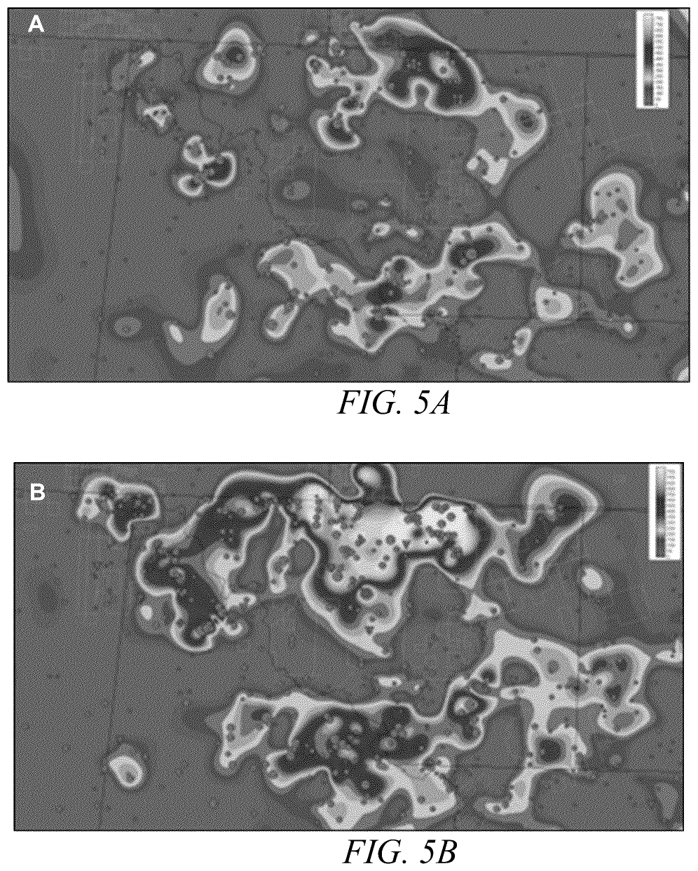

FIG. 5A illustrates an example graphical representation of pore pressure at a first year for an example reservoir. FIG. 5B illustrates an example graphical representation of pore pressure at a second year for an example reservoir. The data utilized may be observed/actual data. The system 100 may use the data to generate graphical representations of pore pressure for one or more years and/or to provide a pressure profile for one or more reservoirs for a period of time (e.g., pressure per year, pressure per month, etc.). Analyzing previously captured data and present data provides a view of relative pore pressure change at given location and/or provides insight into SWD impacts over time. While the relative pore pressure may not reflect absolute pore pressure at a subsurface location, the relative pore pressure can help estimate the effects of changes in pressure and/or aid in forecasting future pore pressures. Such data may be utilized by the uncertainty estimation system 202, the correlation system 204, and/or the optimization system 208 to refine one or more of the processing techniques described above.

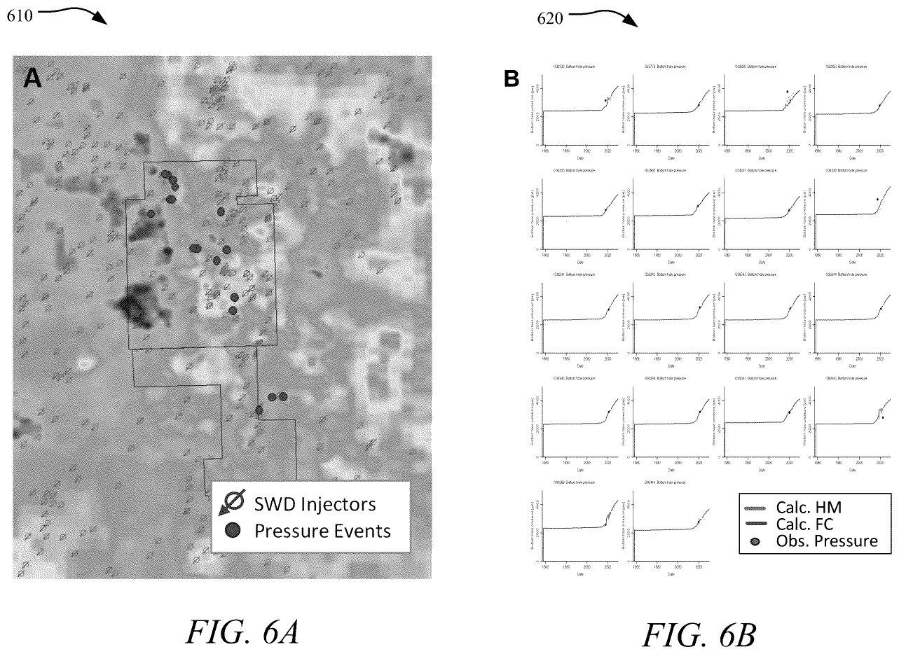

FIG. 6A illustrates a graphical representation of an example area 610 including SWD injectors and pressure events, while FIG. 6B illustrates a graphical representation of calculated parameters 620 for the example area in FIG. 6A, including history matching (HM), Forecasting data (FC), and observed pressure. The example area 610 is a large area, which includes SWD injector location and pressure events (e.g. actual or observed data from kicks while drilling through the SWD formation). Such data may be used to train the machine learning model. In some aspects, the example area 610 and/or the graphical representation of the calculated parameters 620 for the example area 610 may be output to the user device 104 by the output system 210.

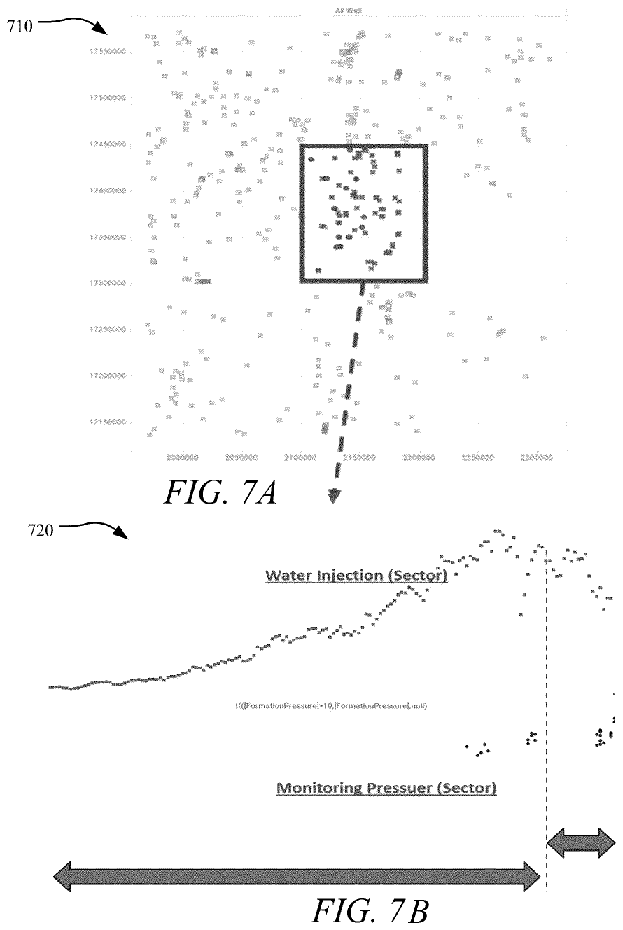

FIG. 7A depicts a graphical representation of a synthetic sector model 710 for the example area in FIGS. 6A and 6B. FIG. 7B depicts a graphical representation of actual water injections and simulated monitoring pressures 720 for the example area 610 in FIGS. 6A and 6B. Referring back to FIG. 7A, synthetic pressure data may be generated by extracting a small subset from a full dataset of raw reservoir data and creating a reservoir model using the data available for the subset including historical injection rates, well locations, and available pressure data. Synthetic pressure data may be calculated through time-intensive reservoir simulation. Actual/observed pressure data may include actual field monitoring pressure from the wells included in the full data set which may be used to generate a reservoir simulation. Pressure data used in training is shown as an open X with a filled interior and pressure data not used in training is shown as an open X without fill. Initially, for example, as shown in FIG. 7B, a larger data set may be used to train the model followed by a limited data set for a back-test. Although the training is conducted with five ESMDA iterations for preconditioning followed by EnKF, more iterations or fewer iterations may be used. The PV and K may be locally adjusted at event points using ESMDA/EnKF to reduce uncertainty. PV and K may then be interpolated across the reservoir through RBF.

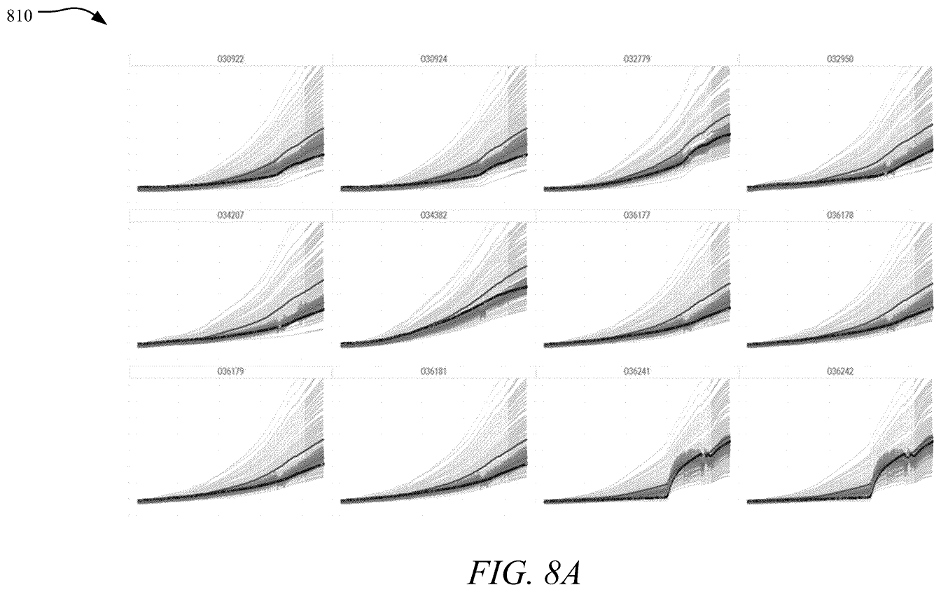

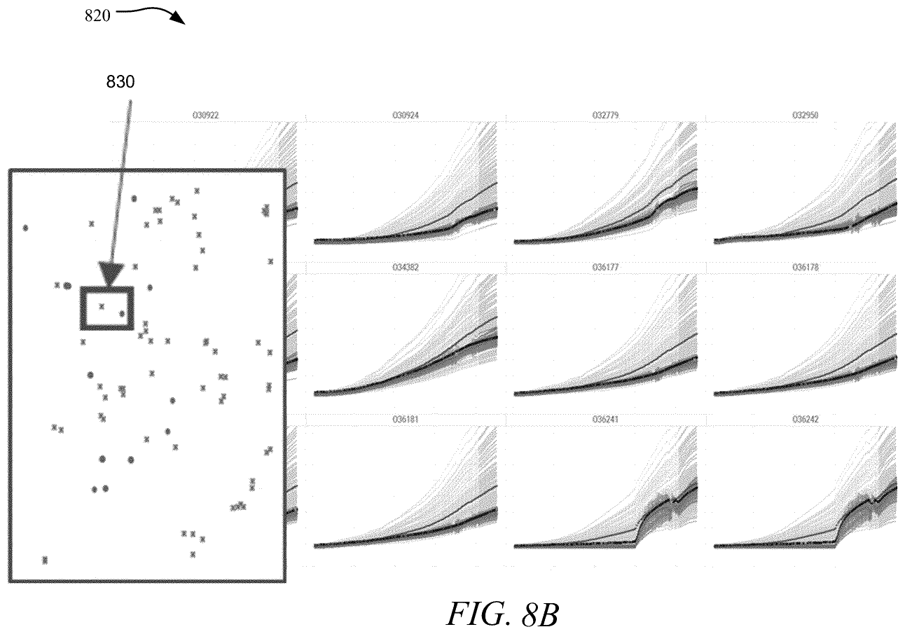

FIG. 8A illustrates a graphical representation 810 of example performance analytics including synthetic pressure data. FIG. 8B illustrates a graphical representation 820 of example performance analytics including synthetic pressure data with fault blocks. Initially, the model may be run with synthetic pressure data as shown in FIG. 8A. The synthetic pressure data at each well that was used for fitting is data captured while drilling the well in order to mimic real conditions. Although twelve wells are depicted in FIG. 8A, more or fewer wells may be utilized.

In an aspect, an ensemble-based data assimilation approach is applied. Prior ensembles may be represented in lighter shaded lines, prior means may be highlighted as a topmost dark line, and posterior ensembles may be highlighted as darker shaded regions. A bottom-most black line may represent simulated data obtained using the system 100. A subsequent model may be run with synthetic pressure data using fault blocks as shown in FIG. 8B. Two data points used as fault blocks are enclosed in box 830 in the inset graphic. Similar to FIG. 7A, pressure data used in training is shown as an open X with a filled interior and pressure data not used in training is shown as an open X without fill. Prior ensembles may be represented in lighter shaded lines, prior mean may be highlighted as a topmost dark line, and posterior ensembles may be highlighted as darker shaded regions. A bottom-most black line represents the simulated data using the system 100.

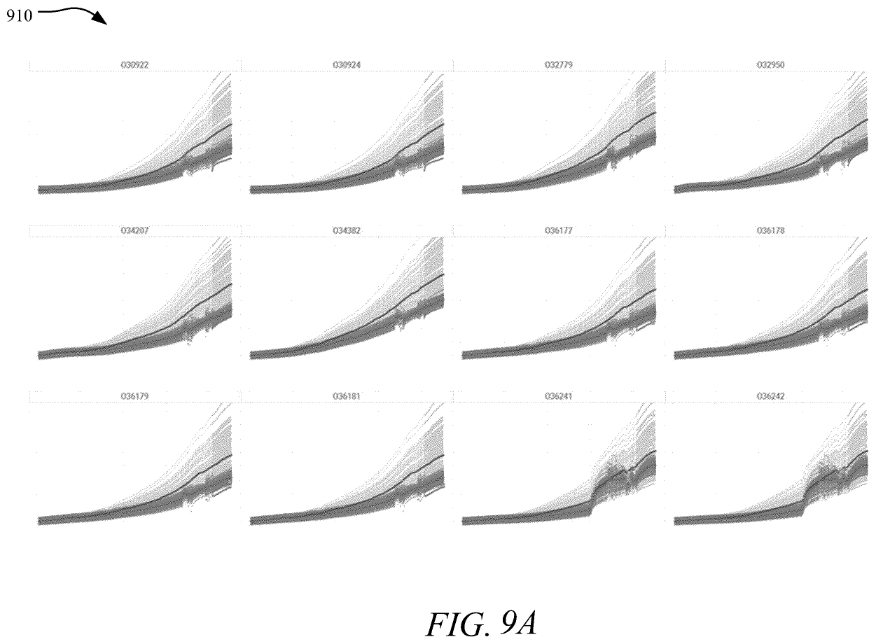

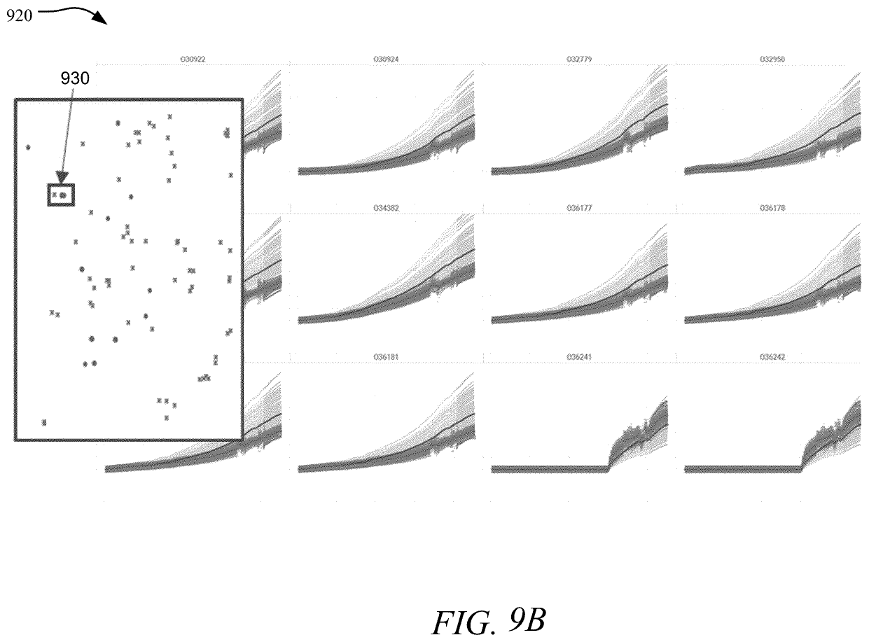

FIG. 9A illustrates a graphical representation 910 of example performance analytics including actual pressure data. FIG. 9B illustrates a graphical representation 920 of example performance analytics including actual pressure data with fault blocks 930. For both FIG. 9A and FIG. 9B, pressure data used in training is shown as an open X with a filled interior, pressure data not used in training are shown as an open X without fill. Prior ensembles are represented in lighter shaded lines, prior mean is highlighted as a topmost dark line, and the posterior ensembles are highlighted as darker shaded regions. A bottom-most black line represents the simulated data using the system 100.

In order to obtain the simulated data using the system 100 for comparison in FIGS. 8A, 8B, 9A, and 9B, automated processing of SWD wells were performed using both synthetic and semi-real pressure data. With a model representation, automated assimilation prevents overfitting and generates probabilistic pressure forecasts based on the underlying uncertainty. The system 100 is easier to maintain, may be updated with less effort, and provides a more frequent pressure forecast that can be updated periodically as the data is obtained. In some embodiments, the SWD pressure may be forecast in real time. In some examples, the data may be updated more frequently in order to aid real-time forecasting.

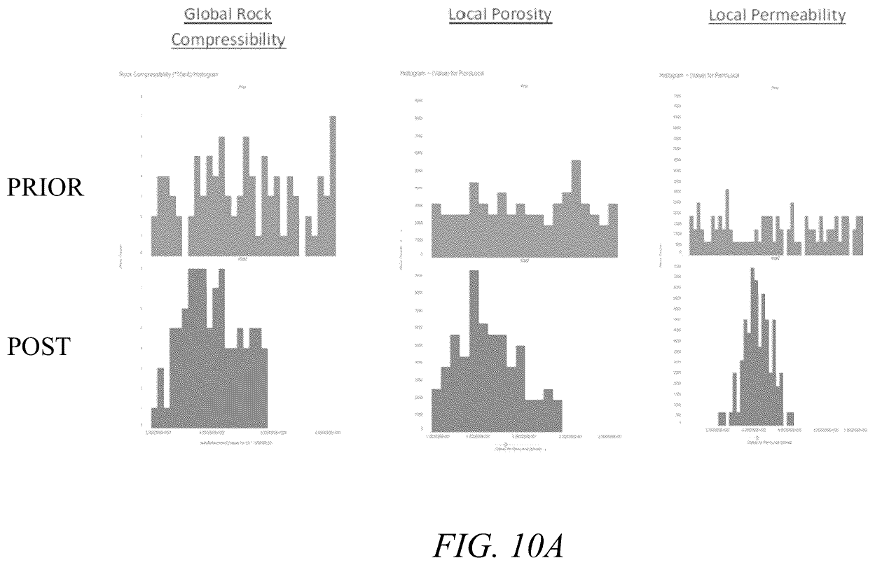

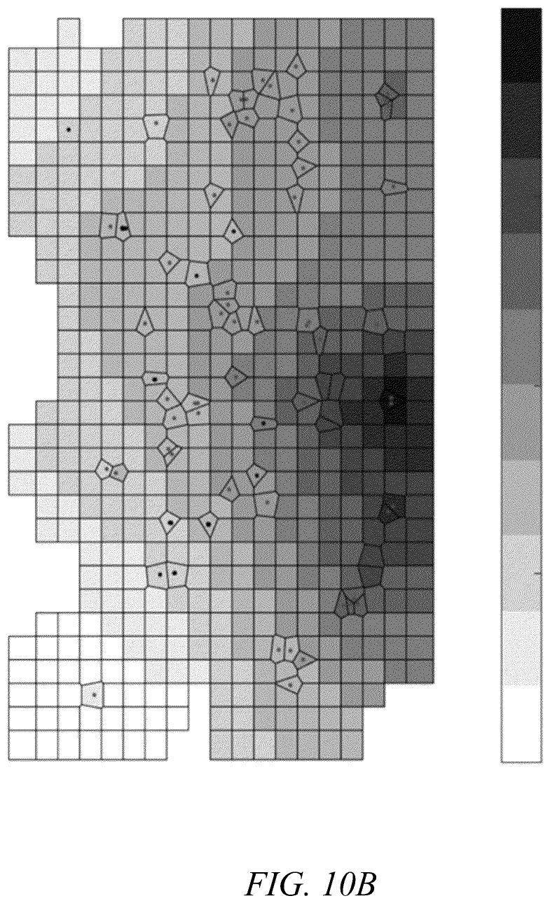

FIG. 10A shows an example graphical representation of improved uncertainty using the various systems and methods discussed herein. For example, FIG. 10A depicts a consolidation of uncertainty parameters, such as global rock compressibility, local porosity, and local permeability in each of the graphical representations after using the methods and systems described herein, relative to the graphical representations in the top row, prior to the optimization. As can be seen from FIG. 10A, in the row or graphs labeled “PRIOR,” uncertainty parameters, such as global rock compressibility, local porosity, local permeability, calculated prior to systems and methods disclosed provide limited insights as the data does not provide trends and/or other useful information. After using the systems and methods described herein, the graphs labeled “POST” (depicted underneath the “PRIOR” row) provide trends and/or insights into the uncertainty parameters depicted.

FIG. 10B shows an example graphical representation of pressure prediction using the various systems and methods discussed herein. The system 100 can effectively use sparse data to predict pressure responses from water injection. In some aspects, the system 100 may be used in areas ranging from one or more smaller areas to much larger areas with larger datasets to predict pressure response due to SWD activities in these areas. In some aspects, the system 100 may propose new injection strategies to reduce D&C risks. The updated pressure map shows an estimated pressure mean which provides insightful information regarding pressure. For example, FIG. 10B provides a pressure map depicting a mean pressure that is qualitatively similar to an actual field monitoring pressure map. The pressure map may be displayed on a user device 104, such as described above, and a user may utilize a user interface, for example, to input data and/or manipulate the plot to generate one or more new pressure maps or update the generated pressure map(s) based on different and/or additional reservoir data, uncertainty data, etc., thus allowing the user to further optimize saltwater disposal at an unconventional reservoir.

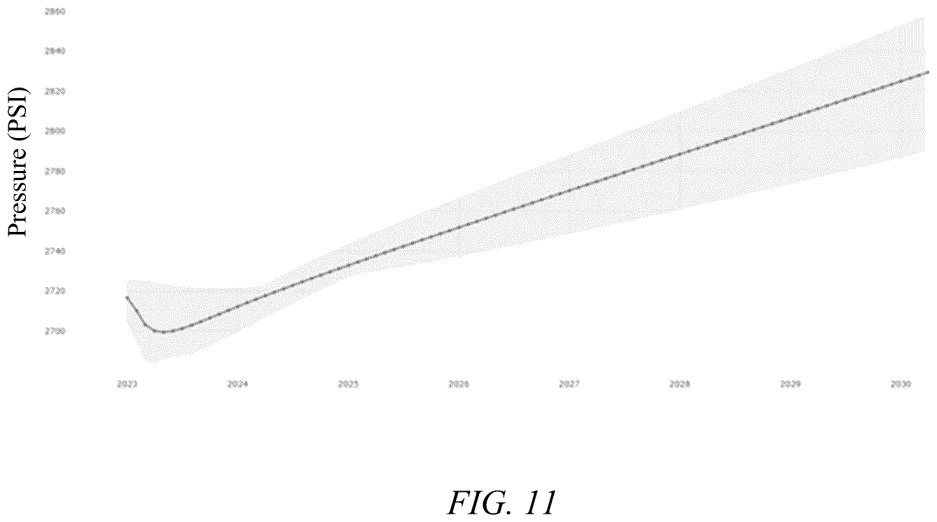

FIG. 11 illustrates an example graphical representation of forecast pressure that may be used and/or generated using the various systems and methods described herein. The graphical representation provides forecast pressure for future years to indicate predicted pressure for a particular reservoir. Although the plot provides pressure information for a reservoir, the plot may provide pressure information for an area, including one or more reservoirs. The plot may be displayed on a user device 104 and/or utilizing a computing device 302, such as described above with reference to FIGS. 1-3. A user may utilize a user interface generated by the user device 104 and/or computing device 302, for example, to input data and/or manipulate the optimized development plan generated by the system 100, to modify scenarios and/or generate new scenarios based on different and/or additional reservoir data, uncertainty data, etc., thus allowing the user to further optimize the generated plot.

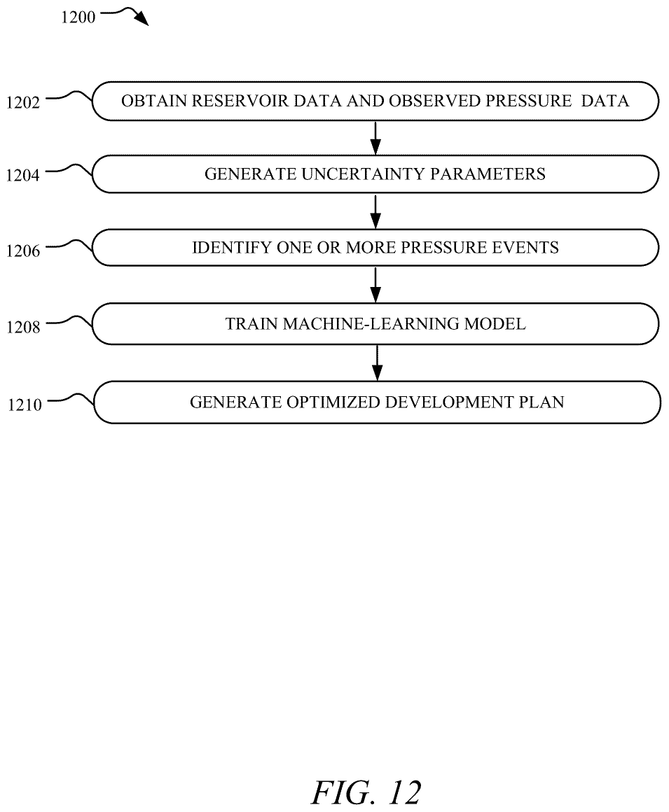

Turning to FIG. 12, example operations 1200 for optimizing saltwater disposal for an unconventional reservoir are shown. In one implementation, an operation 1202 receives reservoir data and pressure data. The reservoir data may include saltwater disposal parameters, such as top hole pressure (THP), bottom hole pressure (BHP), reservoir pressure, mud weight (MW), kick pressure, or any combination thereof.

An operation 1204 generates uncertainty parameters, which may be a distribution of uncertainty parameters. The uncertainty parameters may include ϕ (porosity), K (permeability), NTG (net to gross), Cr (rock/pore compressibility), Pᵢₙᵢₜ, or any combination of these parameters. For example, a model utilizing RBFs can be used to approximate solutions and uncertainty parameters for areas where rate and/or pressure data is not available (e.g., at some well locations). Computing uncertainty parameters at well locations and using approximation of uncertainty parameters helps capture the heterogeneous characteristics of one or more well reservoirs.

An operation 1206 identifies one or more pressure events at one or more locations in a completion interval. For example, the operation may identify SWD injector location information and data related to one or more pressure events, such as top-hole pressure (THP), bottom hole pressure (BHP), reservoir pressure, mud weight (MW), kick pressure, etc. The identified pressure events and/or the location(s) may be associated with historical injection and pressure data to produce correlated pressure data.

In an implementation, operation 1208 may use the correlated pressure data and the uncertainty parameters to train one or more machine learning models of the data physics engine. In some implementations, operation 1208 may also train the one or more machine learning models using differences between the adjusted uncertainty parameters and the observed data. The differences may be, for example, mud weights from an influx event, long term shut in, etc.

In one implementation, an operation 1210 generates an optimized development plan using prediction data generated by the one or more machine learning models. The prediction data is generated by inputting the reservoir data into the one or more machine learning models. The discrepancies between the adjusted uncertainty parameters of operation 1208 and the observed data may be used by ESMDA and EnKF to update the adjusted uncertainty parameters for one or more iterations. The system 100 may generate multiple realizations in an ensemble of data and/or smooth the ensemble of uncertainties one or more times. In some aspects, generating the optimized development plan may include forecasting pressure changes for a reservoir undergoing saltwater disposal. Generating the development plan may include outputting the development plan for display and/or manipulation by a user via one or more output systems 210 and/or one or more computing devices 302.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

The described disclosure may be provided as a computer program product, or software, which may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for optimizing saltwater disposal, the method comprising:
receiving reservoir data and pressure data from at least one of a computing device, one or more sensors, or one or more databases;
generating uncertainty parameters using the reservoir data;
identifying one or more pressure events at one or more locations using the pressure data;
generating correlated pressure data based on a correlation of the one or more pressure events with historical data;
generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and
generating an optimized development plan for the reservoir using the prediction data.

2. The method of claim 1, further comprising:
modifying at least one of a drilling operation or a well operation using the optimized development plan.

3. The method of claim 1, wherein the reservoir data includes at least one of a top hole pressure, a bottom hole pressure, a reservoir pressure, a mud weight, or a kick pressure.

4. The method of claim 1, further comprising:
generating an output based on the prediction data, the output including at least one of a pressure map or a plot for the reservoir.

5. The method of claim 1, wherein the one or more machine learning models are trained by:
updating the uncertainty parameters; and
reducing a distribution of the uncertainty parameters.

6. The method of claim 1, wherein the historical data includes at least one of historical pressure data or historical injection data.

7. The method of claim 1, wherein the one or more machine learning models are trained by determining differences between the correlated pressure data and the uncertainty parameters.

8. One or more tangible non-transitory computer-readable storage media storing computer-executable instructions for performing a computer process on a computing system, the computer process comprising:
receiving reservoir data and pressure data from at least one of a computing device, one or more sensors, or one or more databases;
generating uncertainty parameters using the reservoir data;
identifying one or more pressure events at one or more locations using the pressure data;
generating correlated pressure data based on a correlation of the one or more pressure events with historical data;
generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and
generating an optimized development plan for the reservoir using the prediction data.

9. The one or more tangible non-transitory computer-readable storage media of claim 8 storing additional computer-executable instructions for performing the computer process, the computer process further comprising:
modifying at least one of a drilling operation or a well operation using the optimized development plan.

10. The one or more tangible non-transitory computer-readable storage media of claim 8, wherein the reservoir data includes at least one of a top hole pressure, a bottom hole pressure, a reservoir pressure, a mud weight, or a kick pressure.

11. The one or more tangible non-transitory computer-readable storage media of claim 8 storing additional computer-executable instructions for performing the computer process, the computer process further comprising:
generating an output based on the prediction data, the output including at least one of a pressure map or a plot for the reservoir.

12. The one or more tangible non-transitory computer-readable storage media of claim 8, wherein the one or more machine learning models are trained by:
updating the uncertainty parameters; and
reducing a distribution of the uncertainty parameters.

13. The one or more tangible non-transitory computer-readable storage media of claim 8,
wherein the historical data includes at least one of historical pressure data or historical injection data.

14. The one or more tangible non-transitory computer-readable storage media of claim 8, wherein the one or more machine learning models are trained by determining differences between the correlated pressure data and the uncertainty parameters.

15. A system for optimizing a development plan for a natural resource production system, the system comprising:
a processing system in communication with a computing device, one or more sensors and one or more databases over a network, the processing system receiving reservoir data and pressure data from at least one of the computing device, the one or more sensors, or the one or more databases;
an uncertainty estimation system generating uncertainty parameters using the reservoir data;
a correlation system identifying one or more pressure events at one or more locations using the pressure data and generating correlated pressure data based on a correlation of the one or more pressure events with historical data; and
an optimization system generating prediction data indicating a predicted pressure change for a reservoir undergoing saltwater disposal, the prediction data generated based on the reservoir data using one or more machine learning models, the one or more machine learning models trained using the correlated pressure data and the uncertainty parameters; and
generating an optimized development plan for the reservoir using the prediction data.

16. The system of claim 15, further comprising an output system generating an output based on the prediction data, the output including at least one of a pressure map or a plot for the reservoir.

17. The system of claim 15, wherein the reservoir data includes at least one of a top hole pressure, a bottom hole pressure, a reservoir pressure, a mud weight, or a kick pressure.

18. The system of claim 15, wherein the one or more machine learning models are trained by determining differences between the correlated pressure data and the uncertainty parameters.

19. The system of claim 15, wherein the optimization system modifies at least one of a drilling operation or a well operation using the optimized development plan.

20. The system of claim 15, wherein the optimization system generates a command to cause saltwater to be injected into a disposal well in the reservoir based on the optimized development plan.
